(19) United States
(12) Patent Application Publication
(10) Pub. No.: US 2011/0272401 A1
(43) Pub. Date: Nov. 10, 2011

(54) Apparatus And Method To Form A Fabric Blanket Into A Box

(76) Inventor: Linsi Allyson Tarsia, Milwaukie, OR (US)

(21) Appl. No.: 12/777,166

(22) Filed: May 10, 2010

(51) Int. Cl. B65D 33/02; B31B 3/00; A63H 33/00

(52) U.S. Cl. 220/9.2; 446/488; 493/162

(57) ABSTRACT

Embodiments of the invention relate to apparatuses and methods for forming a fabric blanket having a plurality of reinforced panels into a box. In one embodiment, the fabric blanket includes, when oriented upon a substantially horizontal plane, fifteen panels arranged into three rows in which five panels constitute a first row, five panels constitute a second row, and five panels constitute a third row, and in which seven reinforced panels of the fabric blanket correspond to a box bottom, an interior box top, an exterior box top, a first box end, a second box end, a first box side, and a second box side, when each is respectively oriented into a three dimensional shape to form the box. The remaining eight of the fifteen panels each correspond to a foldable panel of the fabric blanket.

### FIELD

Embodiments of the invention relate generally to the field storage apparatuses and more particularly, to a system and method of forming a fabric blanket into a box.

### BACKGROUND

As is well known to parents the world over, children are messy. They leave toys and play objects strewn about a room with little regard to the desires of their parents to pick up after themselves. Ultimately, parents are left to, quite literally, clean up the mess, pick up the toys, and put everything in its place.

Any mechanism by which parents of children, or other persons responsible for children, may simplify the daily chore of cleaning up after children would be a welcome reprieve, especially if such a mechanism resulted in time savings and a saving of effort.

Taught and described herein are novel mechanisms, methods, and apparatuses by which parents may benefit from a potentially time saving apparatus and method. The described invention is, of course, not limited to only parents of children, and the invention is not described or taught in such a limiting way, and thus, is to be understood to be applicable to those areas which fall within the scope of the claims appended to the detailed description portion of this patent application.

### BRIEF DESCRIPTION OF THE DRAWINGS

Embodiments of the present invention are illustrated by way of example, and not by way of limitation, and can be more fully understood with reference to the following detailed description when considered in connection with the figures in which:

FIG. 1 illustrates an exemplary architecture of a fabric blanket having multiple reinforced panels in which embodiments of the present invention may operate;

FIG. 2 illustrates an alternative exemplary architecture of the fabric blanket having multiple reinforced panels in which embodiments of the present invention may operate;

FIG. 3 illustrates an alternative exemplary architecture of the fabric blanket having multiple reinforced panels in which embodiments of the present invention may operate;

FIG. 4 illustrates an alternative exemplary architecture of the fabric blanket having multiple reinforced panels in which embodiments of the present invention may operate;

FIG. 5 illustrates an alternative exemplary architecture of the fabric blanket having multiple reinforced panels in which embodiments of the present invention may operate;

FIG. 6 illustrates an alternative exemplary architecture of the fabric blanket having multiple reinforced panels in which embodiments of the present invention may operate;

FIG. 7 illustrates an alternative exemplary architecture of the fabric blanket having multiple reinforced panels in which embodiments of the present invention may operate;

FIG. 8 illustrates an alternative exemplary architecture of the fabric blanket having multiple reinforced panels in which embodiments of the present invention may operate;

FIG. 9 illustrates an alternative exemplary architecture of the fabric blanket having multiple reinforced panels in which embodiments of the present invention may operate;

FIG. 10 illustrates an alternative exemplary architecture of the fabric blanket having multiple reinforced panels in which embodiments of the present invention may operate;

FIG. 11 illustrates an alternative exemplary architecture of the fabric blanket having multiple reinforced panels in which embodiments of the present invention may operate;

FIG. 12 illustrates an alternative exemplary architecture of the fabric blanket having multiple reinforced panels in which embodiments of the present invention may operate;

FIG. 13 illustrates an alternative exemplary architecture of the fabric blanket having multiple reinforced panels in which embodiments of the present invention may operate;

FIG. 14 illustrates an alternative exemplary architecture of the fabric blanket having multiple reinforced panels in which embodiments of the present invention may operate;

FIG. 15 illustrates an alternative exemplary architecture of the fabric blanket having multiple reinforced panels in which embodiments of the present invention may operate;

FIG. 16A is a flow diagram illustrating a method for folding the fabric blanket into a box in accordance with one embodiment of the present invention; and

FIG. 16B is a flow diagram illustrating a continuation of the method for folding the fabric blanket into a box in accordance with one embodiment of the present invention.

### DETAILED DESCRIPTION

Described herein are apparatuses and methods for forming a fabric blanket having a plurality of reinforced panels into a box. In one embodiment, the fabric blanket includes, when oriented upon a substantially horizontal plane, fifteen panels arranged into three rows in which five panels constitute a first row, five panels constitute a second row, and five panels constitute a third row, and in which seven reinforced panels of the fabric blanket correspond to a box bottom, an interior box top, an exterior box top, a first box end, a second box end, a first box side, and a second box side, when each is respectively oriented into a three dimensional shape to form the box. The remaining eight of the fifteen panels each correspond to a foldable panel of the fabric blanket.

In one embodiment, such a fabric blanket, having the fifteen panels arranged into the three rows includes a center panel in the first row which corresponds to a first reinforced box-end, a center panel in the third row which corresponds to a second reinforced box-end, and a remaining four panels of the first row and a remaining four panels of the third row which are each foldable panels of the fabric blanket. Further, a center panel in the second row corresponds to a reinforced box-bottom, a lateral left-most panel in the second row corresponds to a reinforced interior box-top, a lateral right-most panel in the second row corresponds to a reinforced exterior box-top, a lateral second-to-left-most panel in the second row corresponds to a first reinforced box-side, and lastly, a lateral second-to-right-most panel in the second row corresponds to a second reinforced box-side.

In such an embodiment, folding the fabric blanket into the box includes coupling together, one of the first or second left-most foldable panels of the first row to one of the corresponding first or second left-most foldable panels of the third row, and coupling together, one of the first or second right-most foldable panels of the first row to one of the corresponding first or second right-most foldable panels of the third row. When the respective panels are coupled in such a way, the first reinforced box-end and the second reinforced box-end establish a first and a second end of the box respectively, each in a substantially vertical plane, and the reinforced box-bottom establishes a bottom of the box in the substantially horizontal plane.

In this embodiment, folding the fabric blanket into the box further includes folding the reinforced interior box-top up and over the bottom of the box, orienting the reinforced interior box-top as an interior top of the box in the substantially horizontal plane and orienting the first reinforced box-side as a first side of the box in the substantially vertical plane, and folding the reinforced exterior box-top up and over the bottom of the box and over the top of the interior top of the box, orienting the reinforced exterior box-top as an exterior top of the box in the substantially horizontal plane and orienting the second reinforced box-side as a second side of the box in the substantially vertical plane, thus completing the formation of the fabric blanket into the box.

In the following description, numerous specific details are set forth such as examples materials and uses, etc., in order to provide a thorough understanding of the various embodiments of the present invention. It will be apparent, however, to one skilled in the art that these specific details need not be employed to practice the disclosed embodiments of the present invention. In other instances, well known materials or methods have not been described in detail in order to avoid unnecessarily obscuring the disclosed embodiments.

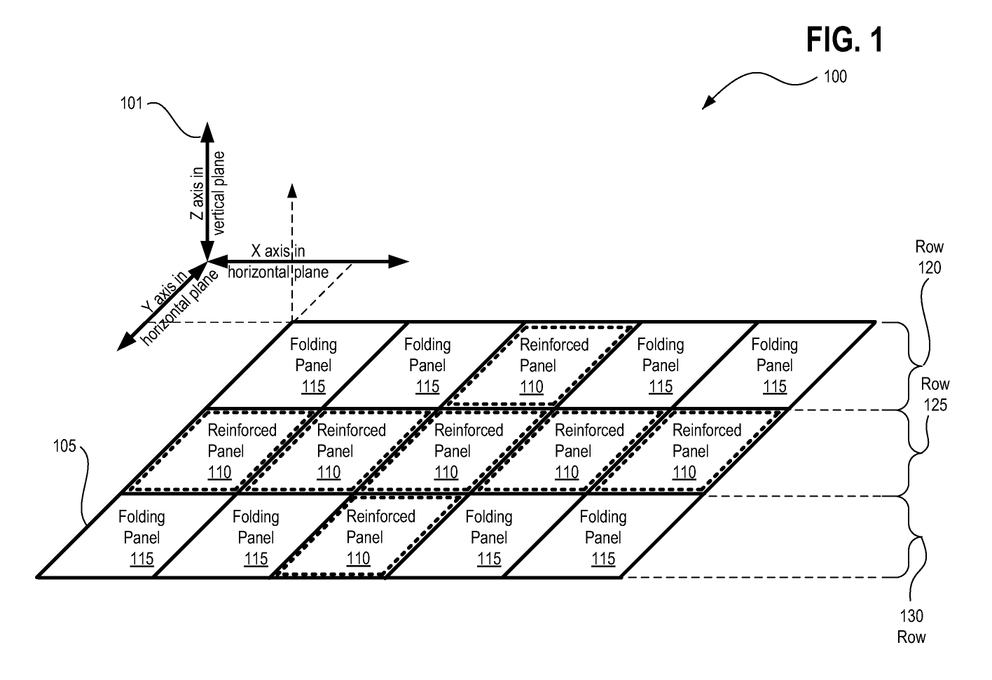

FIG. 1 illustrates an exemplary architecture 100 of the fabric blanket 105 having multiple reinforced panels in which embodiments of the present invention may operate. Element 101 depicts the orientation in which the architecture 100 of the fabric blanket 105 relates. In particular, element 101 depicts a three-dimensional paradigm having an “x” axis and a “y” axis which establish a substantially horizontal plane, and a “z” axis which establishes a substantially vertical plane.

In a particular embodiment, the fabric blanket 105, when outstretched upon a substantially horizontal plane, forms a four-sided blanket in the shape of a rectangle.

In accordance with one embodiment, the fabric blanket 105 includes a plurality of reinforced panels 110 which are denoted in FIG. 1 by the inset dashed lines in each of the multiple reinforced panels 110 shown. In such an embodiment, the fabric blanket 105 is laid or oriented upon a substantially horizontal plane, such as the horizontal plane depicted relative to the fabric blanket 105 by element 101, depicting such an orientation.

As used herein, a substantially horizontal plane or a substantially vertical plane is meant to convey that the referenced object is nearly, or mostly, or almost completely within a horizontal or vertical planar orientation, but not necessarily exact within such a plane. Being oriented “exactly” or “perfectly” within the referenced plane is not necessary to practice the disclosed invention, as will become clear throughout the following description.

In one embodiment, the fabric blanket 105 has fifteen panels (e.g., 110 and 115) which are arranged into three rows 120, 125, and 130. In such an embodiment, five panels constitute a first row 120, five panels constitute a second row 125, and five panels constitute a third row 130.

As can be seen from the embodiment of FIG. 1, the fabric blanket 105 includes seven reinforced panels 110 and eight folding panels. In one embodiment, each of the plurality of reinforced panels 110 is an unyielding rigid reinforcing panel. In a particular embodiment, the reinforced panels 110 are resilient reinforcing panels that readily return to an original form subsequent to a deforming force upon the resilient reinforcing panel, for example, the resilient reinforcing panels may be made of a material known to provide structural rigidity but allow for some flex in various directions, and readily return to an original shape absent a force, such as returning to a flattened panel shape.

In another embodiment, the reinforcing panels may be made up of corrugated cardboard reinforcing panels or structurally reinforced cardboard such as vulcanized cardboard or fiber strengthened cardboard panels. In another embodiment, wooden reinforcing panel are used, and in yet another alternative embodiment, synthetic plastic reinforcing panel are used as each of, or one or more of the reinforced panels 110 of the fabric blanket 105.

The reinforced panels provide structure to the shape of the box once formed from the fabric blanket, for example, allowing the box to resist collapse or substantial deformation.

In a particular embodiment, each of the plurality of reinforced panels 110 includes a reinforcing panel material or reinforcing panel insert that is fixably attached to its respective panel or panel position (e.g., the panel positions upon the fabric blanket 105 denoted by the dashed inset lines in each of the reinforcing panel 110 locations) upon the fabric blanket 105. In a particular embodiment, means for attaching the reinforcing panel 110 to its location upon the fabric blanket 105 includes the reinforcing panel 110 being glued into its respective position, the reinforcing panel 110 being sandwiched between fabric layers of the fabric blanket 105, thus anchoring or securing the reinforcing panel 110 into its respective position and further maintaining the reinforcing panel 110 in its respective position by seams sewn into the fabric of the fabric blanket 105, for example, by a seam on each of four sides surrounding the reinforcing panel 110 relative to its respective position. In an alternative embodiment, the reinforcing panel 110 is fused to the fabric blanket 105 in its respective position, thus becoming an inseparable layer of the fabric blanket 105 fixedly attached to is respective position.

In one embodiment, each of the fifteen panels described relative to the fabric blanket 105 are hingedly attached to each adjacently oriented panel among the fifteen panels of the fabric blanket 105. In one embodiment, means for hingedly connecting each of the fifteen panels to a respective adjacently oriented panel includes using material of the fabric blanket 105 to hingedly connect each of two adjacent panels, using stitching sewn into the material of the fabric blanket 105 to hingedly connect each of two adjacent panels, using a connecting seam sewn into the material of the fabric blanket 105 to hingedly connect each of two adjacent panels, or using a synthetic plastic hinge to hingedly attach each of two adjacent panels, and gluing or sewing the synthetic plastic hinge to the fabric blanket 105 between each panel adjacent to one of the reinforcing panels 110 along a transition between the panel and the adjacent reinforcing panel 110.

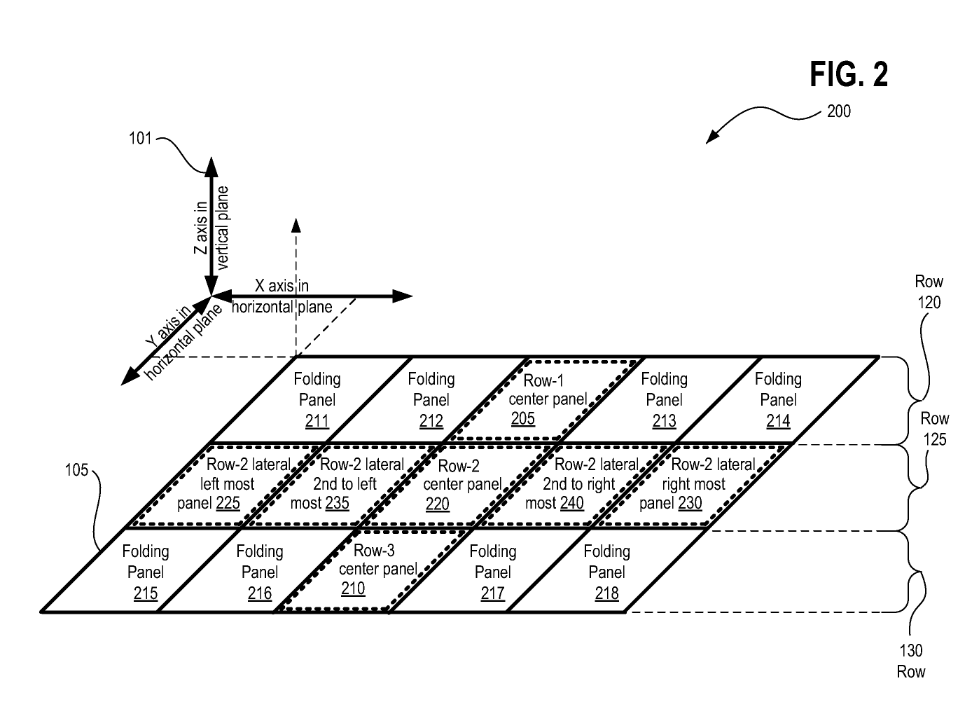

FIG. 2 illustrates an alternative exemplary architecture 200 of the fabric blanket 105 having multiple reinforced panels in which embodiments of the present invention may operate. In accordance with a particular embodiment, a center panel 205 in the first row 120 is (e.g., “corresponds to,” “constitutes,” “establishes,” “orients into” or “becomes”) a first reinforced box end of a box to be formed. In this embodiment, a center panel 210 in the third row 130 is a second reinforced box end of the same box to be formed. For example, first and second ends 205 and 210 respectively will become opposing ends of the same box, oriented parallel to each other, such as two opposite or opposing sides of a box.

In this embodiment of the fabric blanket 105, the remaining four panels 211, 212, 213, and 214 from left to right respectively of the first row 120, and the remaining four panels 215, 216, 217, and 218 from left to right respectively of the third row 130, each correspond to a foldable panel of the box to be formed. There are no foldable panels (e.g., 211 through 218) present in the second row 125; instead, only reinforced panels are depicted in the second row 125.

In this embodiment, a center panel 220 in the second row 125 is a reinforced box bottom of the box to be formed. A lateral left-most panel 225 in the second row 125 is a reinforced interior box top of the box to be formed, and an opposite lateral right-most panel 230 in the second row 125 is a reinforced exterior box top of the box to be formed. Still with respect to the second row 125, a lateral second to left-most panel 235 in the second row 125 is a first reinforced box side of the box to be formed, and a lateral second to right-most panel 240 in the second row 125 is a second reinforced box side of the box to be formed. As with the box ends, the first and second reinforced box sides of the box to be formed (e.g., 235 and 240) will form opposing or opposite box sides parallel to each other respectively.

Thus, as depicted in FIG. 2 and described, six faces of a six faced box are described, each corresponding to one of the depicted reinforced panels (205, 210, 220, 225, 230, 235 and 240), and identified as an interior and exterior “top,” a “bottom,” a first and second “end,” and a first and second “side.” The interior and exterior top corresponding to reinforced panels 225 and 230 respectively will overlap in the box to be formed, and thus, together form only a single face of the six total faces, thus constituting the six box faces from the seven reinforced panels.

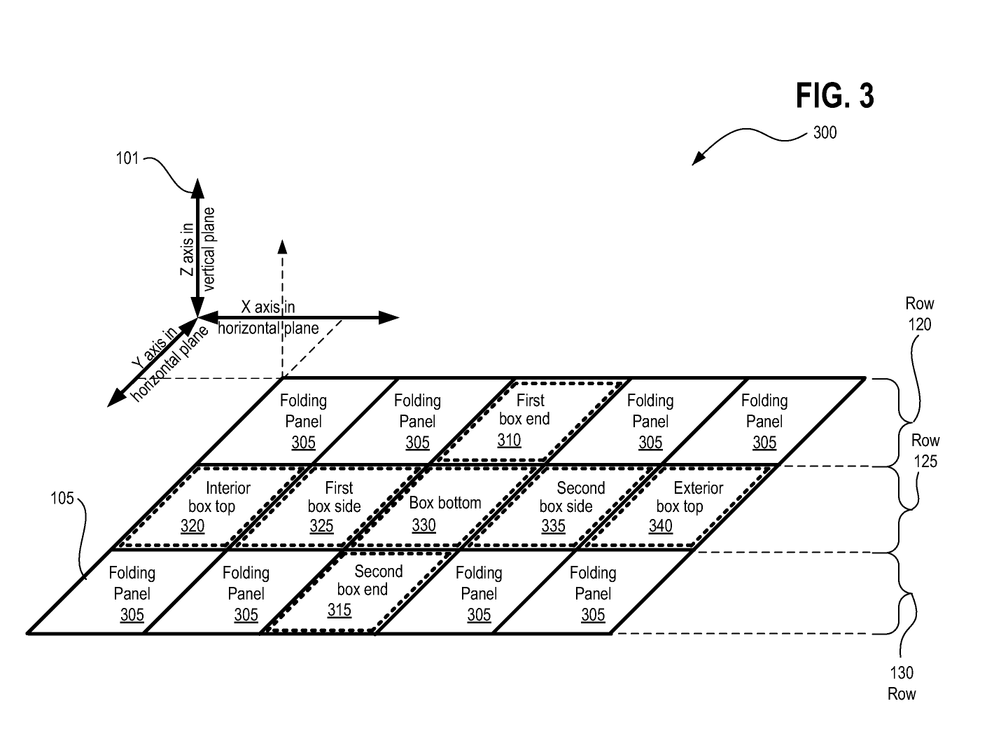

FIG. 3 illustrates an alternative exemplary architecture 300 of the fabric blanket 105 having multiple reinforced panels in which embodiments of the present invention may operate. FIG. 3 further aids in understanding the positioning of the various faces of the box to be formed, relative to each of the identified panels which are described above with reference to FIG. 2.

In this particular embodiment of the fabric blanket 105, the first row 120, second row 125, and third row 130 are again depicted by FIG. 3. Eight folding panels 305 are again depicted. Here, the reinforced panels are identified by their orientation or relative position upon the box that is to be formed from the fabric blanket 105. Specifically, in the first row 120, center position laterally, a first box end 310 is shown. Opposite to this in the third row 130, and again in the center position laterally, a second box end 315 is shown.

In the second row 125 of the fabric blanket 105, the five reinforced panels, going from left to right, are respectively depicted as an interior box top 320 in the laterally left most panel of the second row 125; a first box side 325 in the laterally second to left most panel of the second row 125 (e.g., one panel to the right from the left hand side or the second panel in from the left hand side); a box bottom 330 in the laterally centered panel of the second row 125; a second box side 335 in the laterally second to right most panel of the second row 125; and an exterior box top 340 in the laterally right most panel of the second row 125. The exterior box top 340 and the interior box top 320 are identified as interior and exterior because they will overlap each other upon the box to be formed from the fabric blanket 105, with one being interior to the box and the other being exterior to the box, but both will still be positioned at the top of the box (e.g., in a superior position upon a horizontal plane) when formation of the box from the fabric blanket is complete.

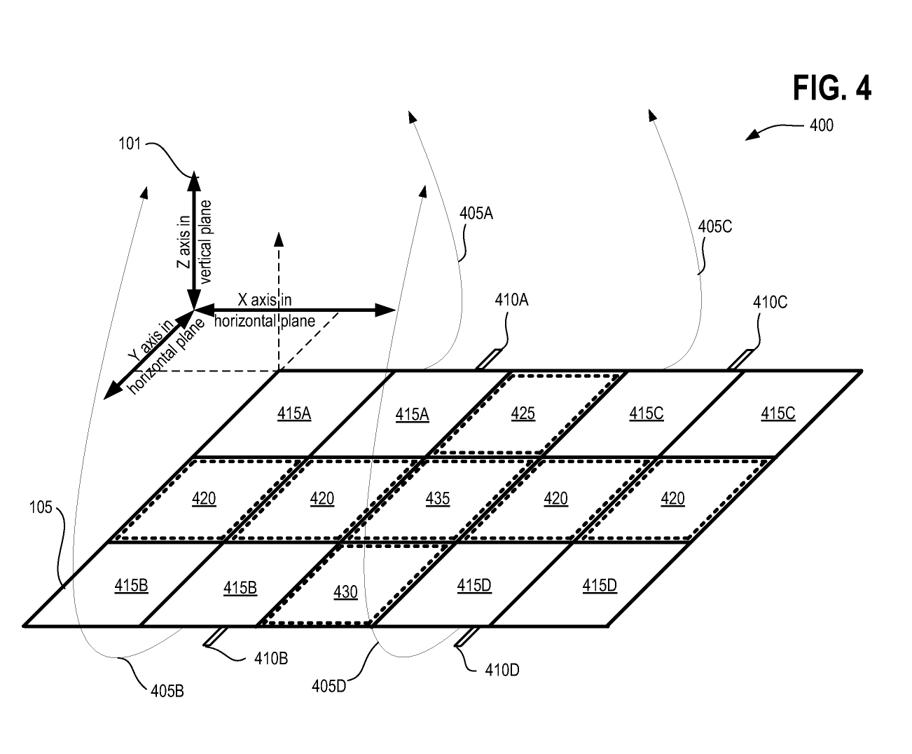

FIG. 4 illustrates an alternative exemplary architecture 400 of the fabric blanket 105 having multiple reinforced panels in which embodiments of the present invention may operate. More particularly, the figure illustrates coupling together, one of the first or second left-most foldable panels 415A of the first row to one of the corresponding first or second left-most foldable panels 415B of the third row, and further coupling together, one of the first or second right-most foldable panels 415C of the first row to one of the corresponding first or second right-most foldable panels 415D of the third row. In such an embodiment, the first reinforced box end 425 and the second reinforced box end 430 become oriented as a first and a second end of the box respectively, each in a substantially vertical plane. Further, in such an embodiment, the reinforced box bottom 435 becomes oriented as a bottom of the box in the substantially horizontal plane.

In a particular embodiment, the means for coupling together one of the first or second left-most foldable panels 415A of the first row to one of the corresponding first or second left-most foldable panels 415B of the third row includes coupling the respective panels via a coupling means 410, such as a clasp, buckle, or strap. For example, coupling means 410A is shown attached to a lateral second to left-most panel in the first row and coupling means 410B is shown attached to a corresponding lateral second to left-most panel in the third row. Additionally shown is a coupling means 410C attached to a second to right most panel in the first row and a coupling means 410D shown attached to a second to right most panel in the third row. Each coupling means 410 couples or attaches to its corresponding coupling means opposite from it, for example, coupling means 410A couples to 410B opposite, and coupling means 410C couples or attaches to coupling means 410D opposite to it.

In another embodiment, one of the first or second right-most foldable panels 415C of the first row is coupled to one of the corresponding first or second right-most foldable panels 415D of the third row similarly via a coupling mechanism or means such as a clasp, buckle, or strap attached the respective panels. In such an embodiment, coupling the respective panels together causes the first end of the box 425 and the second end of the box 430 to reorient from lying in the substantially horizontal plane to forming the first and the second end of the box, each in the substantially vertical plane.

Although the coupling means 410 are shown attached to second to left most, panels of the first and third row and the second to right most panels of the first and third row, the coupling means 410 may alternatively be coupled with the left most panels of the first and third row and the right most panels of the first and third row. A positioning of each of the respective coupling means 410 that is inset approximately one-third of the length of the fabric blanket has been found to aid in causing the fabric blanket 105 to form into the box shape through a grasping and pulling motion of the respective coupling means 410 as described above, in the direction shown by the directional arrows 405A through 405D.

In a particular embodiment, folding the fabric blanket 105 into the box formation includes grasping a first clasp, buckle, or strap (e.g., 410A) and grasping a corresponding and opposite coupling means (e.g., 410B) and pulling the attached panels up and away from the substantially horizontal plane and into a substantially vertical orientation (e.g., pulling up and away as indicated by directional arrows 405A and 405B) by bringing the first clasp, buckle, or strap (e.g., 410A) and the corresponding coupling means (e.g., 410B) toward each other and coupling each together.

In such an embodiment, folding the fabric blanket 105 into the box formation further includes grasping a second clasp, buckle, or strap (e.g., 410C) and grasping the second corresponding coupling means (e.g., 410D) and pulling the attached panels up and away from the substantially horizontal plane and into a substantially vertical orientation (e.g., pulling up and away as indicated by directional arrows 405C and 405D) by bringing the second clasp, buckle, or strap (e.g., 410C) and the second corresponding coupling means (e.g., 410D) toward each other and coupling each together.

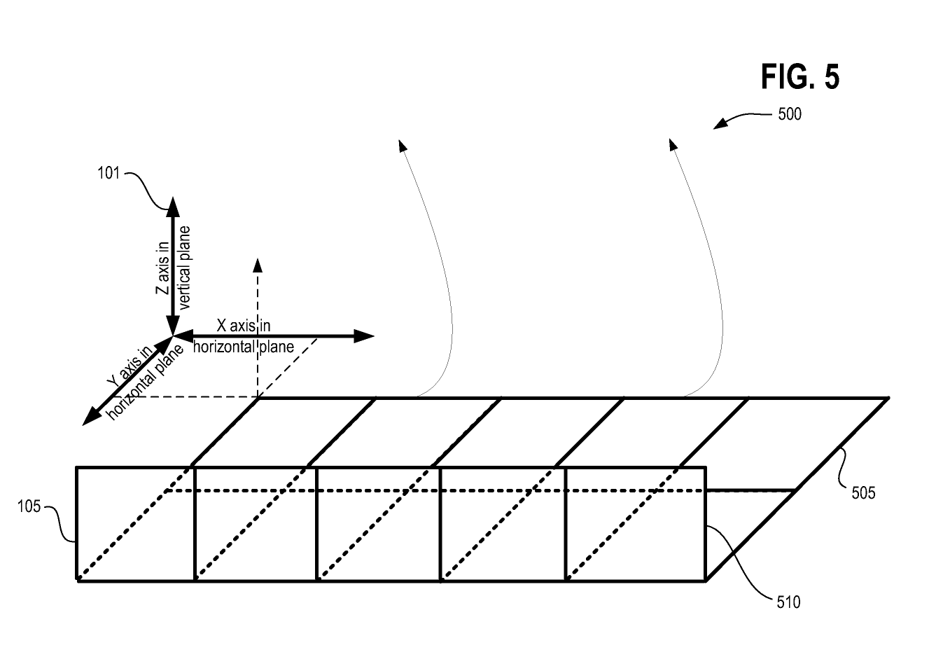

FIG. 5 illustrates an alternative exemplary architecture 500 of the fabric blanket 105 having multiple reinforced panels in which embodiments of the present invention may operate. More particularly, the first row 505 of the fabric blanket 105 is shown still oriented in the substantially horizontal plane, yet to be pulled up and away from the substantially horizontal plane into the substantially vertical plane. Conversely, the third row 510 of the fabric blanket 105 is shown having now been oriented in the substantially vertical plane, having been pulled up and away from the substantially horizontal plane into the substantially vertical plane.

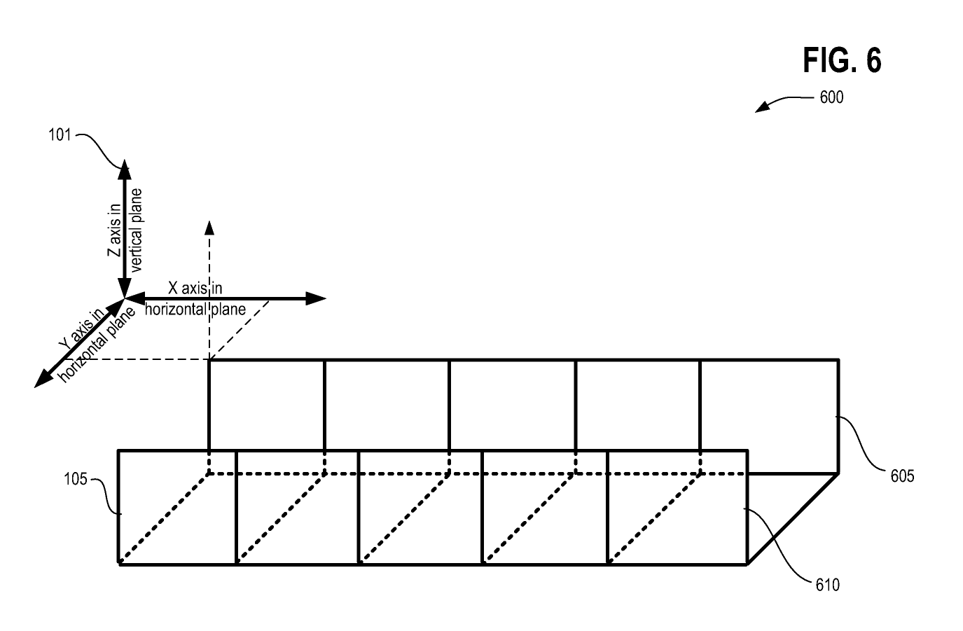

FIG. 6 illustrates an alternative exemplary architecture 600 of the fabric blanket 105 having multiple reinforced panels in which embodiments of the present invention may operate. More particularly, the first row 605 of the fabric blanket 105 and the third row 610 of the fabric blanket 105 are now shown oriented in the substantially vertical plane, having been pulled up and away from the substantially horizontal plane into the substantially vertical plane.

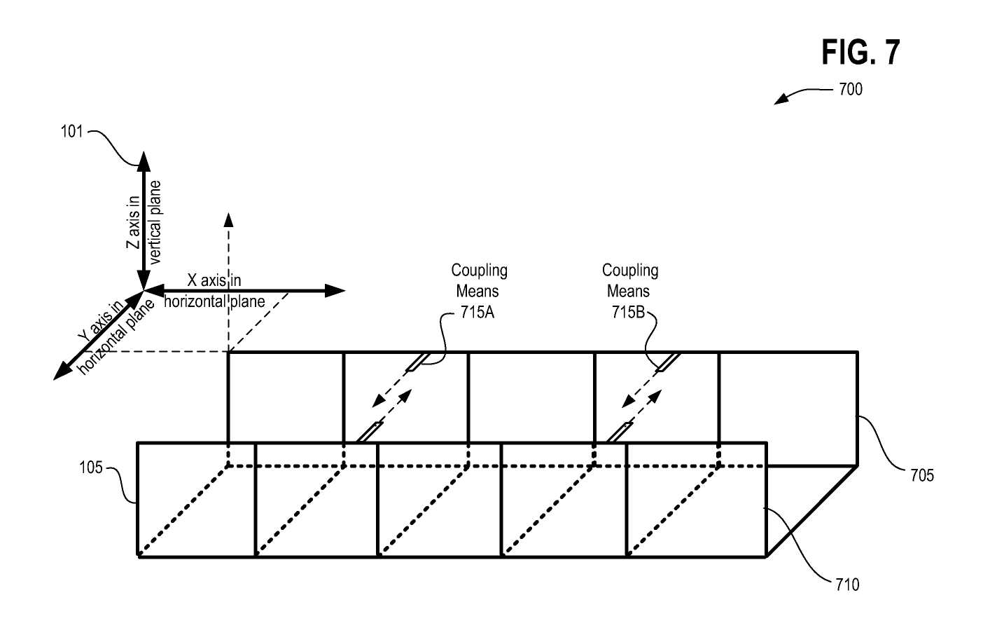

FIG. 7 illustrates an alternative exemplary architecture 700 of the fabric blanket 105 having multiple reinforced panels in which embodiments of the present invention may operate. More particularly, coupling means 715 are illustrated has being directed or pulled or grasped toward a corresponding and opposite coupling means. For example, coupling means 715A attached to the first row 705 is being pulled toward a corresponding coupling means attached to the third row 710, to couple the respectively attached panels to each other. Similarly, coupling means 715B attached to the first row 705 is being pulled toward a corresponding coupling means attached to the third row 710, to couple the respectively attached panels to each other.

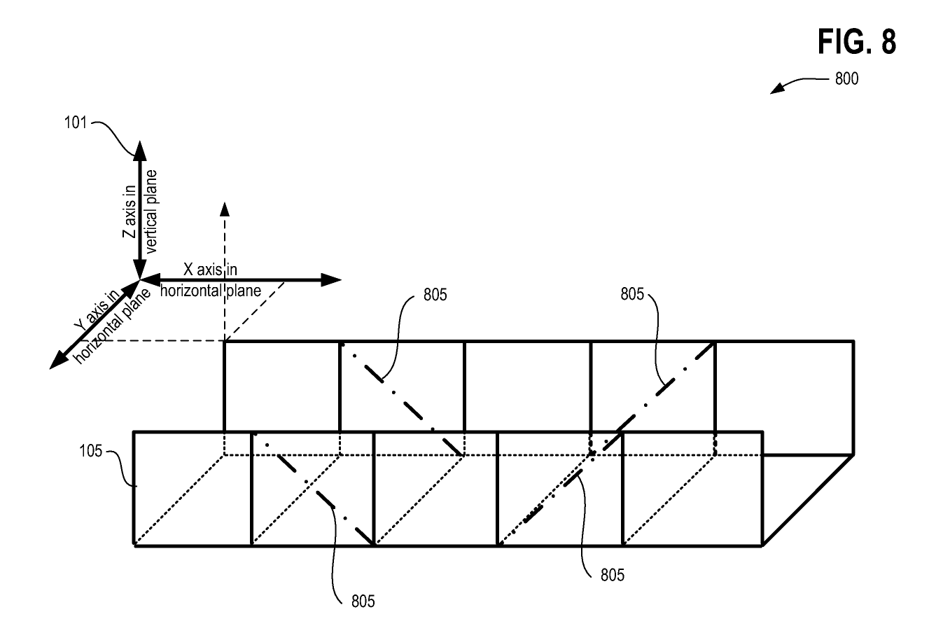

FIG. 8 illustrates an alternative exemplary architecture 800 of the fabric blanket 105 having multiple reinforced panels in which embodiments of the present invention may operate. More particularly, folding lines 805 are now depicted within each of the folding panels located laterally second to left or second to right of the first and third rows. In one embodiment, the panels fold inward substantially along the folding lines 805 shown in the formation of the fabric blanket 105 into the box.

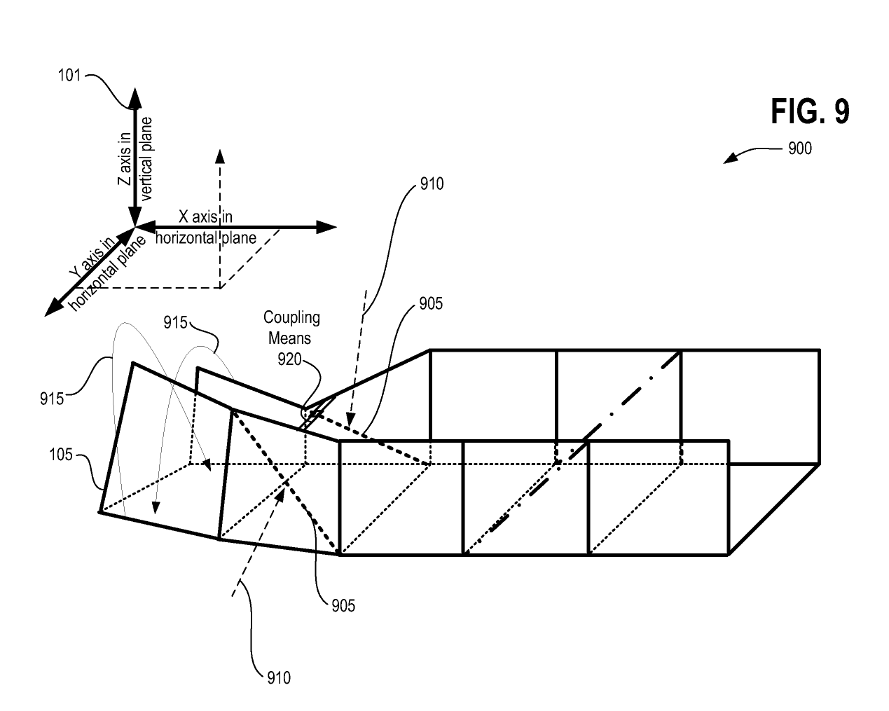

FIG. 9 illustrates an alternative exemplary architecture 900 of the fabric blanket 105 having multiple reinforced panels in which embodiments of the present invention may operate. More particularly, the folding lines 905 are now being folded inward, toward the interior space of the partially formed box. The inward pointing arrows 910 depict that the fold lines 905 are being pressed or collapsed inward.

Additionally shown are the left most panel of the first row and the left most panel of the third row being folded or collapsed in and down as depicted by the directional arrows 915. Coupling means 920 depicts the respectively attached panels coupled together as described above.

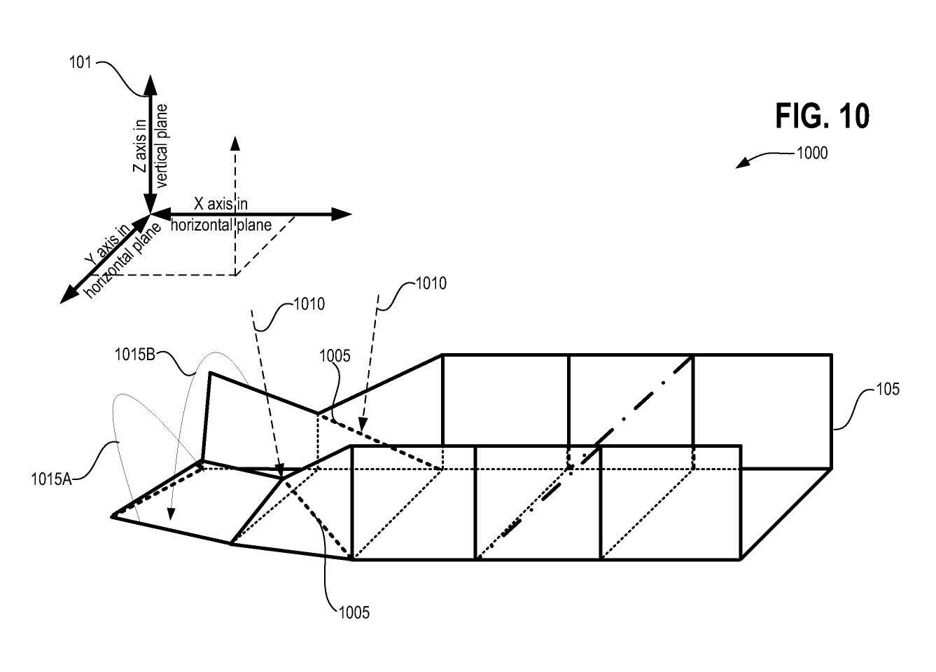

FIG. 10 illustrates an alternative exemplary architecture 1000 of the fabric blanket 105 having multiple reinforced panels in which embodiments of the present invention may operate. More particularly, the left most panel of the first row and the left most panel of the third row are being folded or collapsed in and down as depicted by the directional arrows 1015. The left most panel of the third row is now shown nearly completely collapsed from a previous vertical planar orientation into a now present substantially horizontal planar orientation as depicted by directional arrow 1015A. The left most panel of the first row associated with directional arrow 1015B is to be folded down into a substantially horizontal plane. Additionally shown are the folding lines 1005 being collapsed further inward in comparison to the depiction of FIG. 9, as indicated by the inward facing arrows 1010.

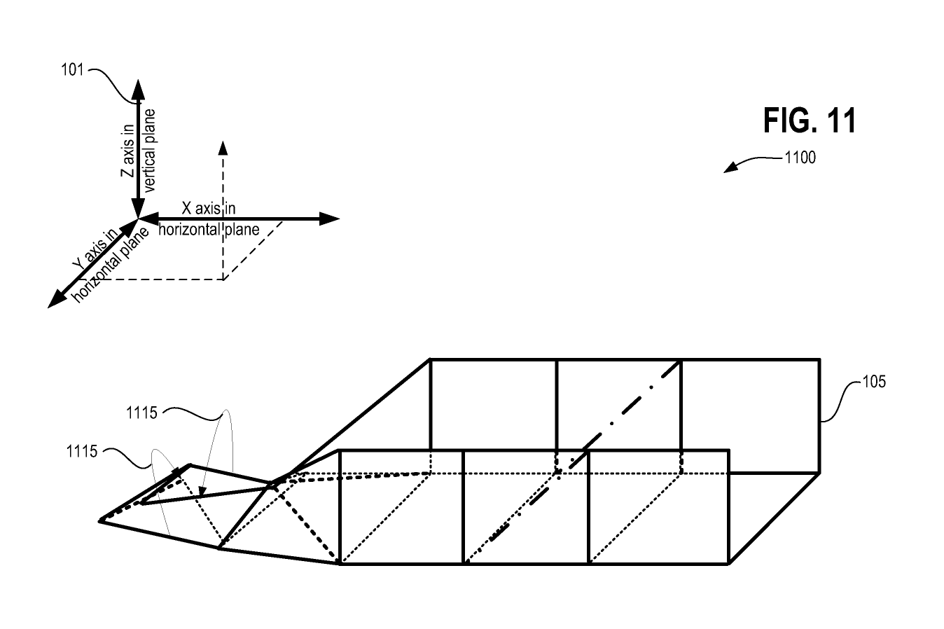

FIG. 11 illustrates an alternative exemplary architecture 1100 of the fabric blanket 105 having multiple reinforced panels in which embodiments of the present invention may operate. More particularly, now shown are the lateral left most panel of the first row and the second row nearly completely collapsed inward from a previous vertical planar orientation into a substantially horizontal planar orientation, as indicated by the associated directional arrows 1115.

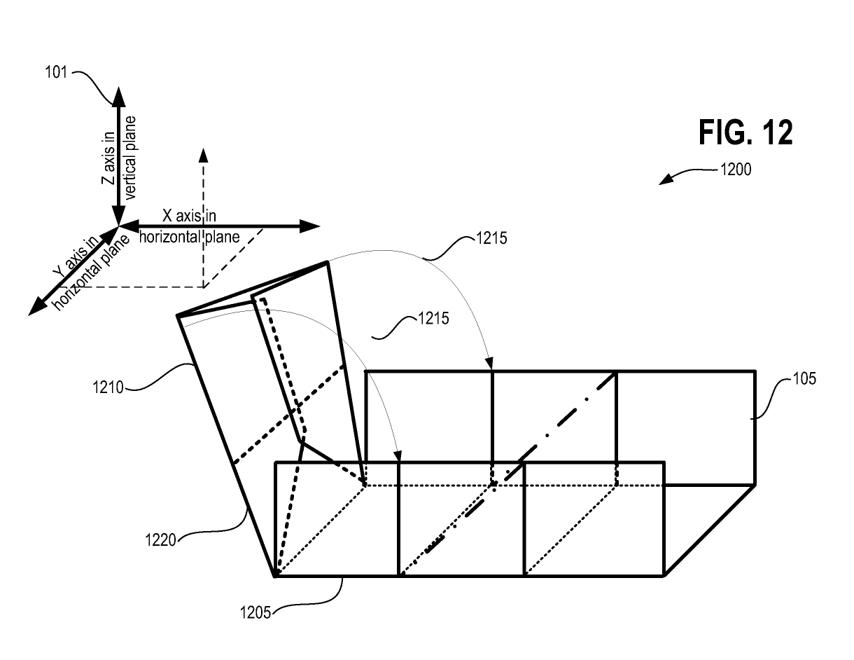

FIG. 12 illustrates an alternative exemplary architecture 1200 of the fabric blanket 105 having multiple reinforced panels in which embodiments of the present invention may operate. In one embodiment, folding the fabric blanket 105 into the box formation includes folding the reinforced interior box top 1210 up and over the bottom of the box 1205, as indicated by directional arrows 1215, thus orienting the reinforced interior box top 1210 as an interior top of the box in the substantially horizontal plane and orienting the first reinforced box side 1220 as a first side of the box in the substantially vertical plane. As shown, the first reinforced box side 1220 is now oriented into a substantially vertical plane and the reinforced interior box top 1210 is to be folded over into a substantially horizontal plane, but at present is shown in a substantially vertical plane.

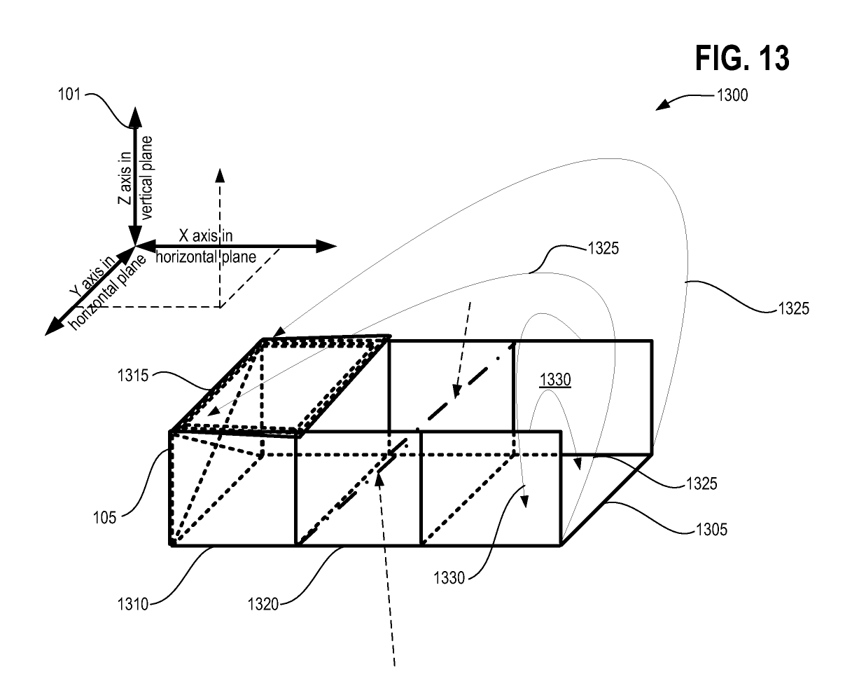

FIG. 13 illustrates an alternative exemplary architecture 1300 of the fabric blanket 105 having multiple reinforced panels in which embodiments of the present invention may operate. In one embodiment, folding the fabric blanket 105 into the box formation further includes folding the reinforced exterior box top 1305 up and over the bottom 1310 of the box and over the top of the interior top 1315 of the box, orienting the reinforced exterior box top 1305 as an exterior top of the box in the substantially horizontal plane and orienting the second reinforced box side 1320 as a second side of the box in the substantially vertical plane completing the formation of the fabric blanket 105 into the box. As shown, the reinforced exterior box top 1305 and the second reinforced box side 1320 are not yet oriented into their respective positions to form the box, but rather, directional arrows 1325 denote the up and over folding direction of the respective panels to form the final box shape. Additionally shown are the right most lateral panel of the first row and the right most lateral panel of the third row to be folded or collapsed inward or down into a substantially horizontal plane, as indicated by directional arrows 1330.

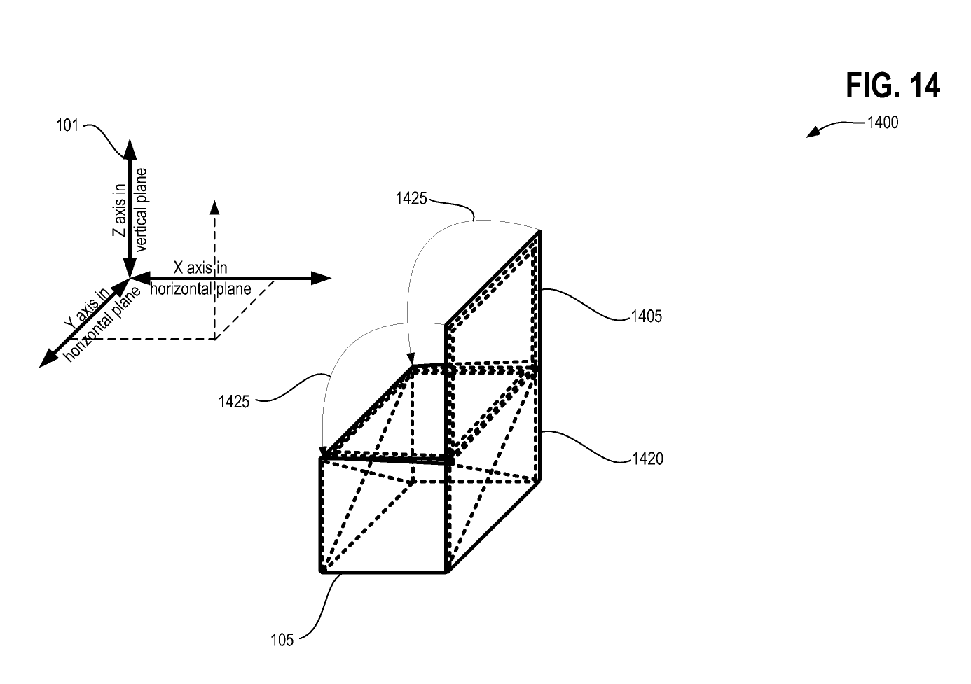

FIG. 14 illustrates an alternative exemplary architecture 1400 of the fabric blanket 105 having multiple reinforced panels in which embodiments of the present invention may operate. More particularly, the reinforced exterior box top 1405 has now been folded up into a substantially vertical orientation and the second reinforced box side 1420 is now also shown oriented into a substantially vertical orientation. Directional arrows 1425 denote the “over” folding direction of the reinforced exterior box top 1405 to form the final box shape. At present however, the reinforced exterior box top 1405 is still in the substantially vertical orientation, having been folded “up” but not yet having been folded “over” into is final substantially horizontal orientation in the formation of the final box shape.

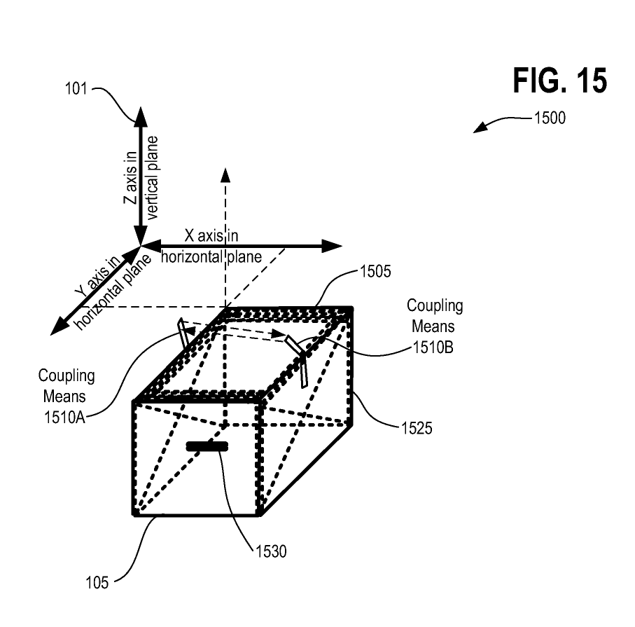

FIG. 15 illustrates an alternative exemplary architecture 1500 of the fabric blanket 105 having multiple reinforced panels in which embodiments of the present invention may operate. More particularly, shown is the fabric blanket 105 having been formed into its final box formation, with each of the respective six faces of the box now oriented as described above.

In one embodiment, folding the fabric blanket 105 into the box formation further includes securing the fabric blanket 105 into the final box formation via a two-part coupling means 1510A and 1510B, wherein a first part of the two-part coupling means 1510A is attached to the reinforced exterior box top 1505, and wherein the second part of the two-part coupling means 1510B is attached to the first reinforced box side 1525.

In one embodiment, the fabric blanket 105 in its final box formation further includes a first handle 1530 attached to the first reinforced box end and a second handle attached to the second reinforced box end. In one embodiment, the first handle 1530 and the second handle may be used to lift the box.

In one embodiment, forming the fabric blanket 105 into the box includes forming the fabric blanket 105 into one of three distinct three-dimensional shapes. For example, forming the fabric blanket 105 into a six-faced three-dimensional cube having four vertices/corners, in which each of the four vertices/corners form substantially right-angles, and in which each of six faces of the six-faced three-dimensional cube include a square having substantially equal length sides each at substantially right angles to one another.

In another embodiment, one of the three distinct three-dimensional shapes includes a six-faced three-dimensional rectangular prism having four vertices/corners, in which each of the four vertices/corners form substantially right-angles, and in which each of six faces of the six-faced three-dimensional rectangular prism each include a rectangle shape having four vertices/corners at substantially right angles.

In yet another embodiment, one of the three distinct three-dimensional shapes includes a six-faced three-dimensional cuboid having four vertices/corners, in which each of the four vertices/corners form substantially right-angles, and in which two of six faces of the six-faced three-dimensional cuboid include a square shape having substantially equal length sides forming substantially right angle vertices/corners, and in which a remaining four of the six faces of the six-faced three-dimensional cuboid each include a rectangle having four sides forming substantially right angle vertices/corners.

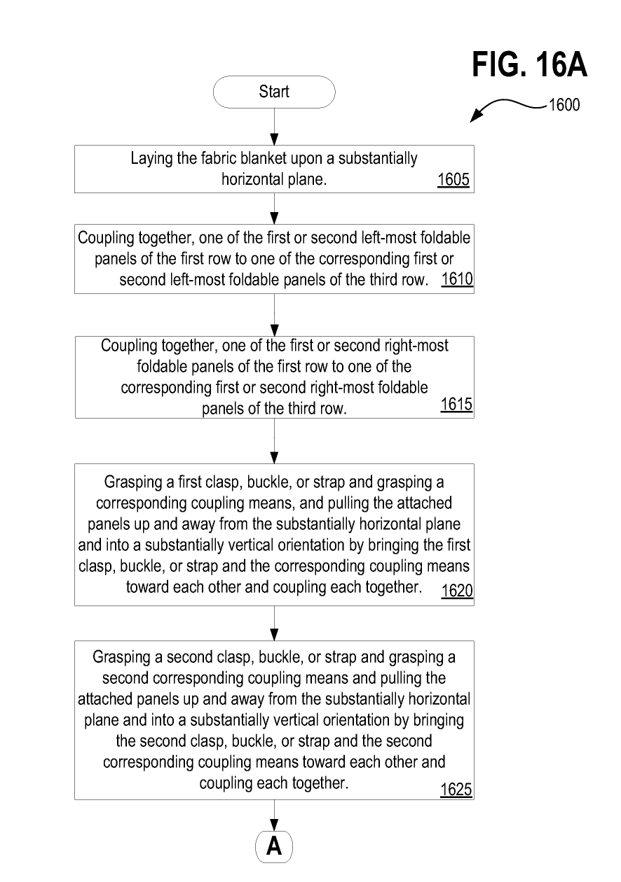

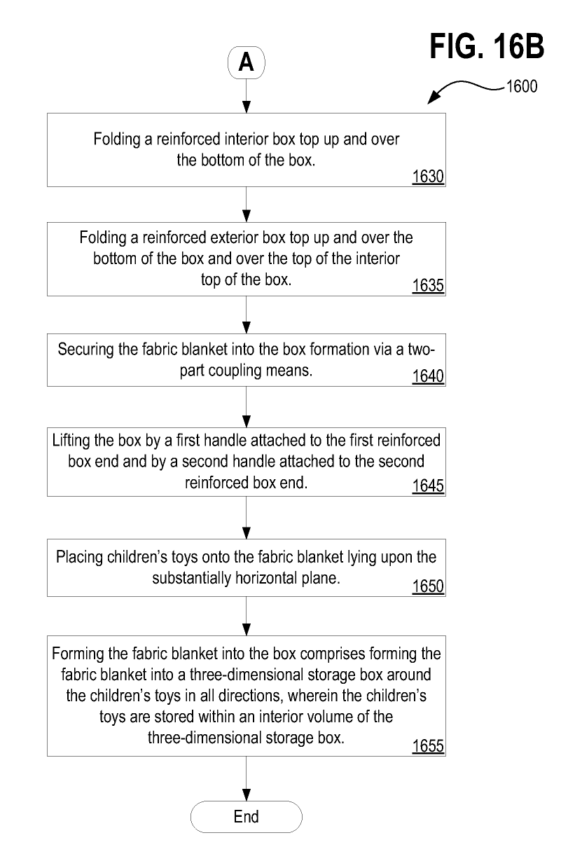

FIGS. 16A and 16B set forth a flow diagram illustrating a method 1600 for folding a fabric blanket (e.g., such as fabric blanket 105 of FIG. 1) into a box in accordance with one embodiment of the present invention. FIG. 16A illustrates a first portion of the method 1600 and FIG. 16B illustrates a continuation of the method 1600. Each is connected via connector element “A.”

Method 1600 begins with block 1605 by laying the fabric blanket upon a substantially horizontal plane. Block 1610 describes coupling together, one of the first or second left-most foldable panels of the first row of the fabric blanket to one of the corresponding first or second left-most foldable panels of the third row of the fabric blanket. Block 1615 describes coupling together, one of the first or second right-most foldable panels of the first row of the fabric blanket to one of the corresponding first or second right-most foldable panels of the third row of the fabric blanket.

In one embodiment, coupling the respective foldable panels together includes grasping a first clasp, buckle, or strap and grasping a corresponding coupling means, and pulling the attached panels up and away from the substantially horizontal plane and into a substantially vertical orientation by bringing the first clasp, buckle, or strap and the corresponding coupling means toward each other and coupling each together (block 1620). In another embodiment, coupling the respective foldable panels together includes grasping a second clasp, buckle, or strap and grasping a second corresponding coupling means and pulling the attached panels up and away from the substantially horizontal plane and into a substantially vertical orientation by bringing the second clasp, buckle, or strap and the second corresponding coupling means toward each other and coupling each together (block 1625).

Block 1630 of method 1600 (passing through connector “A” from FIG. 16A to FIG. 16B) describes folding a reinforced interior box top up and over the bottom of the box and block 1635 describes folding a reinforced exterior box top up and over the bottom of the box and over the top of the interior top of the box.

Block 1640 describes securing the fabric blanket into the box formation via a two-part coupling means. For example, such coupling means may include a clasp, buckle, strap, snaps, etc.

Block 1645 describes lifting the box by a first handle attached to the first reinforced box end and by a second handle attached to the second reinforced box end.

Block 1650 describes placing children's toys onto the fabric blanket, when the fabric blanket is lying upon the substantially horizontal plane, and block 1655 describes forming the fabric blanket into the box around the children's toys. For example, in one embodiment, forming the fabric blanket into the box around the children's toys includes forming the fabric blanket into a three-dimensional storage box around the children's toys in all directions, wherein the children's toys are stored within an interior volume of the three-dimensional storage box.

The above description is intended to be illustrative, and not restrictive. Many other embodiments will be apparent to those of skill in the art upon reading and understanding the above description. The scope of the invention is therefore determined in reference to the appended claims, along with the full scope of equivalents to which such claims are entitled.

What is claimed is:

1. A method of forming a fabric blanket having a plurality of reinforced panels into a box, the method comprising:
laying the fabric blanket upon a substantially horizontal plane, wherein the fabric blanket comprises:
fifteen panels arranged into three rows in which five panels constitute a first row, five panels constitute a second row, and five panels constitute a third row,
wherein a center panel in the first row comprises a first reinforced box-end,
wherein a center panel in the third row comprises a second reinforced box-end,
wherein a remaining four panels of the first row and a remaining four panels of the third row each comprise a foldable panel,
wherein a center panel in the second row comprises a reinforced box-bottom,
wherein a lateral left-most panel in the second row comprises a reinforced interior box-top,
wherein a lateral right-most panel in the second row comprises a reinforced exterior box-top,
wherein a lateral second-to-left-most panel in the second row comprises a first reinforced box-side, and
wherein a lateral second-to-right-most panel in the second row comprises a second reinforced box-side;
coupling together, one of the first or second left-most foldable panels of the first row to one of the corresponding first or second left-most foldable panels of the third row;
coupling together, one of the first or second right-most foldable panels of the first row to one of the corresponding first or second right-most foldable panels of the third row, the first reinforced box-end and the second reinforced box-end being oriented as a first and a second end of the box respectively, each in a substantially vertical plane, and the reinforced box-bottom being oriented as a bottom of the box in the substantially horizontal plane;
folding the reinforced interior box-top up and over the bottom of the box, orienting the reinforced interior box-top as an interior top of the box in the substantially horizontal plane and orienting the first reinforced box-side as a first side of the box in the substantially vertical plane; and
folding the reinforced exterior box-top up and over the bottom of the box and over the top of the interior top of the box, orienting the reinforced exterior box-top as an exterior top of the box in the substantially horizontal plane and orienting the second reinforced box-side as a second side of the box in the substantially vertical plane, completing the formation of the fabric blanket into the box.

2. The method of claim 1:
wherein coupling together, one of the first or second left-most foldable panels of the first row to one of the corresponding first or second left-most foldable panels of the third row comprises coupling a clasp, buckle, or strap attached to a lateral second-to-left-most panel in the first row and coupling the clasp, buckle, or strap with a corresponding coupling means attached to the lateral second-to-left-most panel in the third row; and
wherein coupling together, one of the first or second right-most foldable panels of the first row to one of the corresponding first or second right-most foldable panels of the third row comprises coupling a second clasp, buckle, or strap attached to a lateral second-to-right-most panel in the first row and coupling the second clasp, buckle, or strap with a second corresponding coupling means attached to the lateral second-to-right-most panel in the third row, wherein the coupling together causes the first and the second end of the box to reorient from lying in the substantially horizontal plane to forming the first and the second end of the box, each in the substantially vertical plane.

3. The method of claim 2, further comprising:
grasping the first clasp, buckle, or strap and grasping the corresponding coupling means and pulling the attached panels up and away from the substantially horizontal plane and into a substantially vertical orientation by bringing the first clasp, buckle, or strap and the corresponding coupling means toward each other and coupling each together; and
grasping the second clasp, buckle, or strap and grasping the second corresponding coupling means and pulling the attached panels up and away from the substantially horizontal plane and into a substantially vertical orientation by bringing the second clasp, buckle, or strap and the second corresponding coupling means toward each other and coupling each together.

4. The method of claim 1, further comprising securing the fabric blanket into the box formation via a two-part coupling means, wherein a first part of the two-part coupling means is attached to the reinforced exterior box-top, and wherein the second part of the two-part coupling means is attached to the first reinforced box-side.

5. The method of claim 1, further comprising lifting the box by a first handle attached to the first reinforced box-end and by a second handle attached to the second reinforced box-end.

6. The method of claim 1, wherein the fabric blanket comprises a four-sided blanket in the shape of a rectangle.

7. The method of claim 1, wherein each of the plurality of reinforced panels comprises a material selected from the group comprising:
a unyielding rigid reinforcing panel;
a resilient reinforcing panel to readily return to an original form subsequent to a deforming force upon the resilient reinforcing panel;
a corrugated cardboard reinforcing panel;
a wooden reinforcing panel; and
a synthetic plastic reinforcing panel.

8. The method of claim 7, wherein each of the plurality of reinforced panels comprises a reinforcing panel fixably attached to its respective panel upon the fabric blanket by a means selected from the group comprising:
the reinforcing panel being glued into its respective position;
the reinforcing panel being sandwiched between fabric of the fabric blanket in its respective position and maintained in its respective position by seams sewn into the fabric of the fabric blanket on each of four sides surrounding the reinforcing panel in its respective position; and
the reinforcing panel being fused to the fabric blanket in its respective position becoming an inseparable layer of the fabric blanket in its respective position.

9. The method of claim 1, wherein each of the fifteen panels is hingedly attached to each adjacently oriented panel among the fifteen panels of the fabric blanket by a means selected from the group comprising:
material of the fabric blanket hingedly connecting each of two adjacent panels;
a stitching sewn into the material of the fabric blanket hingedly connecting each of two adjacent panels;
a seam sewn into the material of the fabric blanket hingedly connecting each of two adjacent panels; and
a synthetic plastic hinge hingedly attaching each of two adjacent panels, the synthetic plastic hinge glued or sewn to the fabric blanket between at least each panel adjacent to one of the plurality of reinforcing panels along a transition between the panel and the adjacent one of the plurality of reinforcing panels.

10. The method of claim 1, wherein forming the fabric blanket into the box comprises forming the fabric blanket one three-dimensional shape selected from the group comprising:
a six-faced three-dimensional cube having four vertices/corners, in which each of the four vertices/corners form substantially right-angles, and in which each of six faces of the six-faced three-dimensional cube comprise a square having substantially equal length sides each at substantially right angles;
a six-faced three-dimensional rectangular prism having four vertices/corners, in which each of the four vertices/corners form substantially right-angles, and in which each of six faces of the six-faced three-dimensional rectangular prism comprise a rectangle shape having four vertices/corners at substantially right angles; and
a six-faced three-dimensional cuboid having four vertices/corners, in which each of the four vertices/corners form substantially right-angles, and in which two of six faces of the six-faced three-dimensional cuboid comprise a square shape having substantially equal length sides forming substantially right angle vertices/corners, and in which a remaining four of the six faces of the six-faced three-dimensional cuboid comprise a rectangle having four sides forming substantially right angle vertices/corners.

11. The method of claim 1, further comprising:
placing children's toys onto the fabric blanket lying upon the substantially horizontal plane; and
wherein forming the fabric blanket into the box comprises forming the fabric blanket into a three-dimensional storage box around the children's toys in all directions, wherein the children's toys are stored within an interior volume of the three-dimensional storage box.

12. A fabric blanket to be formed into a box, wherein the fabric blanket comprises:
a plurality of reinforced panels that, when oriented upon a substantially horizontal plane, are arranged into:
five panels along a first row,
five panels along a second row,
five panels along a third row,
wherein a center panel in the first row comprises a first reinforced box-end,
wherein a center panel in the third row comprises a second reinforced box-end,
wherein a remaining four panels of the first row and a remaining four panels of the third row each comprise a foldable panel,
wherein a center panel in the second row comprises a reinforced box-bottom,
wherein a lateral left-most panel in the second row comprises a reinforced interior box-top,
wherein a lateral right-most panel in the second row comprises a reinforced exterior box-top,
wherein a lateral second-to-left-most panel in the second row comprises a first reinforced box-side, and
wherein a lateral second-to-right-most panel in the second row comprises a second reinforced box-side;
the fabric blanket further comprising:
a first two-part coupling mechanism to couple one of the first or second left-most foldable panels of the first row to one of the corresponding first or second left-most foldable panels of the third row;
a second two-part coupling mechanism to couple one of the first or second right-most foldable panels of the first row to one of the corresponding first or second right-most foldable panels of the third row, the first reinforced box-end and the second reinforced box-end being oriented as a first and a second end of the box respectively, each in a substantially vertical plane, and the reinforced box-bottom being oriented as a bottom of the box in the substantially horizontal plane;
the reinforced interior box-top to fold up and over the bottom of the box and orient into an interior top of the box in the substantially horizontal plane above the bottom of the box, and the first reinforced box-side to orient as a first side of the box in the substantially vertical plane; and
the reinforced exterior box-top to fold up and over the bottom of the box and orient into an exterior top of the box in the substantially horizontal plane over the interior top of the box, and the second reinforced box-side to orient as a second side of the box in the substantially vertical plane to complete the formation of the fabric blanket into the box.

13. The fabric blanket of claim 12:
wherein the first two-part coupling mechanism comprises one of a clasp, buckle, or connecting strap having a first part attached to a lateral second-to-left-most panel in the first row and having a corresponding second part attached a lateral second-to-left-most panel in the third row; and
wherein the second two-part coupling mechanism comprises one of a clasp, buckle, or connecting strap having a first part attached to a lateral second-to-right-most panel in the first row and having a corresponding second part attached a lateral second-to-right-most panel in the third row.

14. The fabric blanket of claim 12, further comprising a two-part securing mechanism having a first part of the two-part securing mechanism attached to the reinforced exterior box-top, and a second part of the two-part securing mechanism attached to the first reinforced box-side, the two-part securing mechanism to couple together via the first part and the second part and secure the fabric blanket into the box formation by securing the exterior top of the box to the first side of the box.

15. The fabric blanket of claim 12, further comprising a first lifting handle attached to the first reinforced box-end and a second lifting handle attached to the second reinforced box-end.

16. The fabric blanket of claim 12, wherein the fabric blanket comprises a four-sided blanket in the shape of a rectangle.

17. The fabric blanket of claim 12:
wherein each of the plurality of reinforced panels comprises a material selected from the group comprising:
a unyielding rigid reinforcing panel,
a resilient reinforcing panel to readily return to an original form subsequent to a deforming force upon the resilient reinforcing panel,
a corrugated cardboard reinforcing panel,
a wooden reinforcing panel,
a synthetic plastic reinforcing panel; and
wherein each of the plurality of reinforced panels comprises the reinforced panel fixably attached to its respective panel upon the fabric blanket by a means selected from the group comprising:
the reinforced panel being glued into its respective position,
the reinforced panel being sandwiched between fabric of the fabric blanket in its respective position and maintained in its respective position by seams sewn into the fabric of the fabric blanket on each of four sides surrounding the reinforcing panel in its respective position, and
the reinforced panel being fused to the fabric blanket in its respective position becoming an inseparable layer of the fabric blanket in its respective position.

18. The fabric blanket of claim 12, wherein the box comprises one three-dimensional shape selected from the group comprising:
a six-sided three-dimensional cube having four vertices/corners, in which each of the four vertices/corners form substantially right-angles, and in which each of six sides of the six-sided three-dimensional cube comprise a square having substantially equal length sides each at substantially right angles;
a six-sided three-dimensional rectangular prism having four vertices/corners, in which each of the four vertices/corners form substantially right-angles, and in which each of six sides of the six-sided three-dimensional rectangular prism comprise a rectangle shape having four vertices/corners at substantially right angles; and
a six-sided three-dimensional cuboid having four vertices/corners, in which each of the four vertices/corners form substantially right-angles, and in which two of six sides of the six-sided three-dimensional cuboid comprise a square shape having substantially equal length sides forming substantially right angle vertices/corners, and in which a remaining four of the six sides of the six-sided three-dimensional cuboid comprise a rectangle having four sides forming substantially right angle vertices/corners.

19. A fabric blanket to be formed into a box, wherein the fabric blanket comprises:
a plurality of reinforced panels that, when oriented upon a substantially horizontal plane, are arranged into a fifteen panel grid having three rows of five panels each,
wherein a center panel in the first row comprises a first reinforced box-end,
wherein a center panel in the third row comprises a second reinforced box-end,
wherein a remaining four panels of the first row and a remaining four panels of the third row each comprise a foldable panel,
wherein a center panel in the second row comprises a reinforced box-bottom,
wherein a lateral left-most panel in the second row comprises a reinforced interior box-top,
wherein a lateral right-most panel in the second row comprises a reinforced exterior box-top,
wherein a lateral second-to-left-most panel in the second row comprises a first reinforced box-side, and
wherein a lateral second-to-right-most panel in the second row comprises a second reinforced box-side;
the fabric blanket further comprising:
means for coupling a second-to-left-most foldable panel of the first row to a second-to-left-most panel of the third row;
means for coupling a second-to-right-most foldable panel of the first row to a second-to-right-most panel of the third row orienting the first reinforced box-end and the second reinforced box-end into a first end of the box and a second end of the box respectively, each in a substantially vertical plane, and the reinforced box-bottom being oriented as a bottom of the box in the substantially horizontal plane;
means for folding reinforced interior box-top up and over the bottom of the box orienting the reinforced interior box-top into an interior top of the box in the substantially horizontal plane above the bottom of the box, and orienting the first reinforced box-side into a first side of the box in the substantially vertical plane; and
means for folding the reinforced exterior box-top up and over the bottom of the box orienting the reinforced exterior box-top into an exterior top of the box in the substantially horizontal plane over the interior top of the box, and orienting the second reinforced box-side into a second side of the box in the substantially vertical plane to complete the formation of the fabric blanket into the box.

20. The fabric blanket of claim 19, wherein each coupling means comprises a linkable clasp, buckle, or strap to be pull an attached panel away from the substantially horizontal plane into the substantially vertical plane.
